(19) United States
(12) Patent Application Publication
(10) Pub. No.: US 2015/0232172 A1
(43) Pub. Date: Aug. 20, 2015

(54) AIRFOIL ASSEMBLY AND METHOD

(71) Applicant: Donald Steve Morris, Encinitas, CA (US)

(72) Inventor: Donald Steve Morris, Encinitas, CA (US)

(21) Appl. No.: 14/185,804

(22) Filed: Feb. 20, 2014

(51) Int. Cl. B64C 21/00; B64C 5/02

(52) U.S. Cl. CPC B64C 21/00; B64C 5/02

(57) ABSTRACT

Airfoil assemblies and methods of using them are provided to accelerate air flow relative to the airfoil assemblies and to improve laminar air flow over airfoils. The airfoil may include a cathode disposed near a leading portion of the airfoil to ionize on rushing air and for initiating an electric field. An anode disposed near an opposite portion of the airfoil completes the electric field to accelerate ionized air flowing relative to the airfoil, whereby ionized positively charged air particles tend to separate and accelerate continuously toward the anode in a substantially smooth laminar path of travel uninterruptedly. An air ionizing antenna may be employed for radiating an electromagnetic field transversely to the electric field to cause the electromagnetic field to ionize additional air flowing relative to the airfoil.

### FIELD OF THE INVENTION

The present invention in general relates to an airfoil assembly and method, and more particularly relates to a method and apparatus for improving laminar air flow relative to an airfoil, such as an aircraft wing, propeller, or other.

### BACKGROUND OF THE INVENTION

There is no admission that the background art disclosed in this section legally constitutes prior art.

There have been various attempts to improve airflow relative to airfoils to make them more efficient. For example, reference may be made to the following patents and publications: U.S. Pat. No. 8,449,255; U.S. Pat. No. 8,308,112; U.S. Pat. No. 8,220,753; U.S. Pat. No. 8,181,910; U.S. Pat. No. 8,016,247; U.S. Pat. No. 8,006,939; U.S. Pat. No. 7,988,101; U.S. Pat. No. 7,870,720; U.S. Pat. No. 7,744,039; U.S. Pat. No. 7,413,149; U.S. Pat. No. 3,452,225; U.S. Pat. No. 3,448,791; U.S. Pat. No. 3,095,163; U.S. Pat. No. 2,946,541; U.S. Pat. Publication No. 2012/02480721; U.S. Patent Publication No. 2011/0253842; Germany Patent Publication No. DE102008001103; France Patent Publication No. FR2091847; and PCT Patent Publication No. WO2008136698.

In U.S. Pat. No. 7,413,139 there is disclosed an air foil system utilizing a series of pairs of positive and negative electrodes spaced apart between the leading portion and the trailing portion of the airfoil for accelerating the flow of ionized fluid media relative to the airfoil. The system is so constructed and arranged that ionized fluid flows close to the surface of the airfoil in a boundary layer. A series of pairs of spaced apart positive and negative electrodes are spaced along the airfoil. As a result, the flow of ionized air is increased between each pair of positive and negative electrodes closely spaced to the surface of the airfoil. By having a series of such pairs of electrodes, the ionized air flow is confined along the boundary layer of the airfoil in an attempt to improve the apparent velocity and effectiveness of the airfoil.

However, by constraining the ionized air close to the surface of the airfoil in a boundary layer, there may be only a limited amount of added lift provided by the limitation on the ionized air flowing relative to the boundary layer only. Also, there may well be a tendency toward an undesirable and unwanted turbulent airflow relative to the airfoil due to the separate ionized air flow paths between each separate pair of electrodes for certain applications.

### BRIEF DESCRIPTION OF THE DRAWINGS

In order to better understand the invention and to see how the same may be carried out in practice, non-limiting preferred embodiments of the invention will now be described with reference to the accompanying drawings, in which:

FIG. 1 is a pictorial diagrammatic view of an airfoil assembly which is constructed in accordance with an embodiment;

FIG. 2 is a cross-sectional diagrammatic view of the airfoil assembly of FIG. 1;

FIG. 3 is a pictorial diagrammatic sectional view of an airfoil assembly which is constructed in accordance with another embodiment;

FIG. 4 is a sectional diagrammatic view of the airfoil assembly of FIG. 3;

FIG. 5 is a pictorial diagrammatic view of airfoil assemblies, which are instructed in accordance with yet another embodiment, and which are illustrated forming a portion of an aircraft; and

FIG. 6 is and enlarged pictorial diagrammatic view of the right side of the vertical stabilizer airfoil assembly of the vertical stabilizer for the aircraft of FIG. 5.

### DETAILED DESCRIPTION OF CERTAIN EMBODIMENTS OF THE INVENTION

Certain embodiments of the present invention will now be described more fully hereinafter with reference to the accompanying drawings, in which some, but not all, embodiments of the invention are shown. Indeed, these embodiments of the invention may be in many different forms and thus the invention should not be construed as limited to the embodiments set forth herein; rather, these embodiments are provided as illustrative examples only so that this disclosure will satisfy applicable legal requirements. Like numbers refer to like elements throughout.

It will be readily understood that the components of the embodiments as generally described and illustrated in the drawings herein, could be arranged and designed in a wide variety of different configurations. Thus, the following more detailed description of the certain ones of the embodiments of the system, components and method of the present invention, as represented in the drawings, is not intended to limit the scope of the invention, as claimed, but is merely representative of the embodiment of the invention.

Airfoil assemblies and methods of using them to improve laminar air flow relative to airfoils are disclosed. The airfoil may include a cathode disposed near a leading portion of the airfoil for initiating an electric field sufficiently strong to ionize oncoming air, up to but not as high as dielectric breakdown. An anode disposed near an opposite portion of the airfoil completes the electric field to accelerate ionized air flowing relative to the airfoil, whereby ionized positively charged air particles tend to separate creating even lower pressure, and accelerate continuously toward the anode in a substantially smooth laminar path of travel uninterruptedly, such as by providing less Brownian motion. An air ionizing antenna may be employed for radiating an electromagnetic field to cause the electromagnetic field to ionize additional air flowing relative to the airfoil.

According to certain embodiments of the airfoil assemblies, there is provided an air ionizing antenna mounted on the airfoil for radiating an electromagnetic field to cause the electromagnetic field to ionize air flowing relative to the airfoil. A source of alternating current energizes the antenna at an air ionizing frequency.

According to further embodiments of the airfoil assemblies, the airfoil may include an elongated recess for receiving the elongated conductor or forming a part of the ionizing antenna. The recess may be covered so that the airfoil may have a substantially smooth contour. A cover (not shown) may have an index of refraction such that the electromagnetic (EM) wave is directed more into the air flow.

According to yet another embodiment of the airfoil assembly, the ionizing antenna includes an elongated horn structure for guiding the electromagnetic radiation away from the airfoil and into the laminar path of travel of the positively charged air particles to increase the number of positively charged air ions flowing toward the anode. The antenna may optionally be positioned for pointing in any suitable direction for ionizing air flow, for example, from back of the airfoil toward the front thereof against the flow of air.

There may be a cover (not shown) over any recess to keep the airfoil smooth. The cover should be composed of a material that does not interfere with ionizing the air by means of the electromagnetic wave being established and maintained.

Further embodiments of the airfoil assembly may be employed on aircraft such as on the upper surface and/or the lower surface of a wing of an aircraft. Furthermore, other embodiments of the airfoil assembly may be employed on an aircraft vertical stabilizer to help steer the aircraft.

A further embodiment relates to a method of improving laminar airflow over an airfoil, and includes positively charging air ions near an edge portion of the airfoil. The electric field is completed to ionize air accelerating relative to the airfoil so that ionized positively charged air particles tend to separate thus creating even lower pressure. The air also accelerates to create lower pressure. The air flows continuously toward the anode in a smooth laminar path of travel, uninterruptedly with reduced random Brownian motion and turbulence, and at a greater velocity than the non-ionized air flowing relative to the moving airfoil.

The on rushing air is ionized by a cathode/anode configuration and an ionizing antenna. The resultant plasma is then accelerated by the electric field lines. This streamlined acceleration of the plasma creates lower pressure and added thrust. Also, due to the reduced random Brownian motion of the cations in the plasma due to the force lines of the electric field, there may be a reduction in turbulence and increased energy efficiency. Due to mutual repulsion of cations, there is even greater reduction in pressure and Brownian motion (turbulence), enhancing lift and energy efficiency.

The increased thrust, energy efficiency, and decreased turbulence may apply to all portions of the craft where the above embodiments are placed and directed rearwardly.

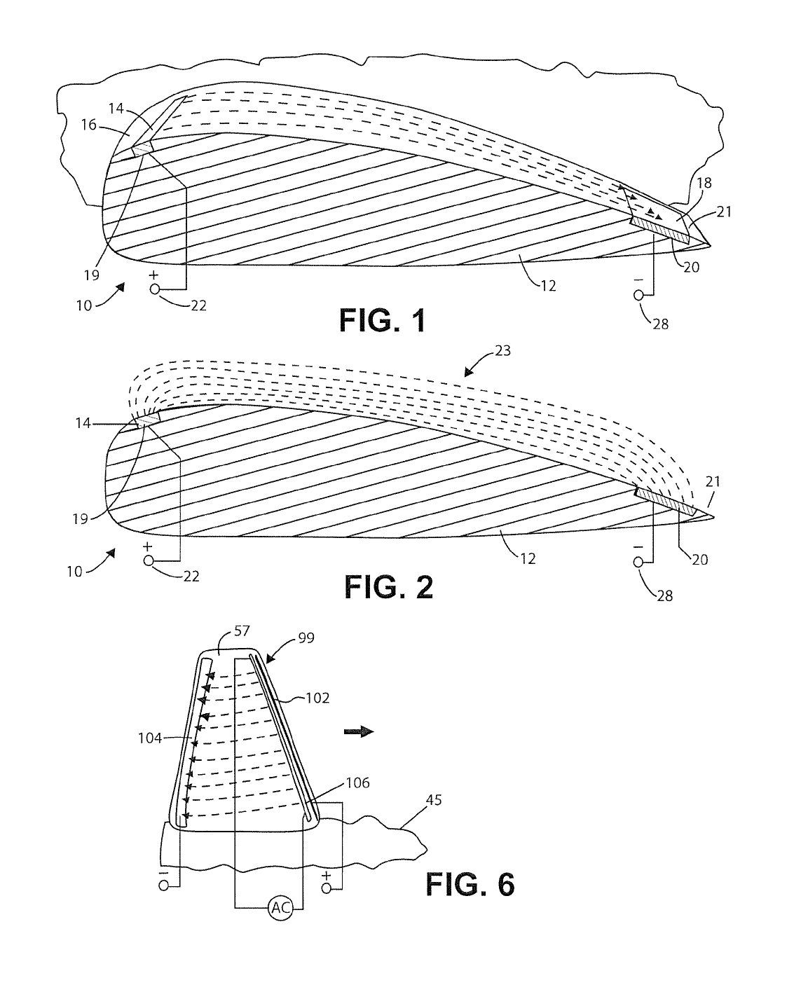

Referring now to the drawings, and more particularly to FIGS. 1 and 2 thereof, there is shown an airfoil assembly 10, which is constructed in accordance with an embodiment. The airfoil assembly 10 includes an airfoil 12 which includes a cathode 14 mounted on its upper surface at its leading portion 16 for cooperating with an anode 18 mounted at a trailing portion 21 of the upper surface of the airfoil 12 for completing an electric field to ionize and accelerate air flowing relative to the upper surface of the airfoil so that ionized positively charged air particles tend to repel further lowering pressure, and thus separate and flow continuously toward the anode in a smooth laminar path of travel 23 uninterruptedly, reducing random Brownian motion and thus turbulence. In so doing, greater volumes of accelerating ionized air move relative to the upper surface of the airfoil to provide greater lift to the airfoil, as well as less turbulence/drag to provide for greater efficiency and speed of the airfoil. It is to be understood that the airfoil may be an aircraft wing, a propeller, or other. Moreover, it may be used with air or other fluids such as water when, for example, used on a water craft.

Considering now the cathode 14 in greater detail, the cathode 14 is in the form of an elongated conductor extending along the length of the airfoil and may be disposed within an opening or recess 19 in the upper surface of the airfoil along the leading portion thereof. In this manner, the cathode 14 may be disposed flush with the upper surface of the airfoil to provide a smoothly contoured uninterrupted upper surface of the airfoil so as not to interfere with air flowing relative thereto. It should be understood that various different lengths of the cathode 14 may be employed. Alternatively, the cathode may be formed of spaced apart independent sections for a wider range of control/navigation. Also, the cross-sectional shape of the cathode 14 may vary such, for example, as rectangular (as show), square, circular and other. The cathode 14 may be disposed as close as possible to the leading portion of the airfoil 12, but it is to be understood that different locations may also be employed depending on the application. The cathode 14 is composed of a suitable conductive material such as copper or other. The cathode may be constructed as thin as possible to enhance ionizing ability.

A positive source 22 of direct current is connected electrically to the cathode 14, and a negative source 28 is connected to the anode 18 to bias the electrodes to cause the air flowing relative to the airfoil 12 to be ionized, whereby an electric field flows from the cathode 14 to the anode 18. The dense electric field lines at the cathode should be sufficient to ionize air flowing relative to the airfoil. A recess or opening 20 in the upper surface of the airfoil 12 at its trailing portion may receive the anode 18 in a similar manner as the cathode 14 is received in its recess 19 in a flush smoothly contoured manner. The anode 18 may be composed of conductive material such as copper or other conductive materials, and may be in the form of a bar which has a width which is substantially greater than the width of the cathode 14 to attract the flow of positively charged spread apart air particles which tend to separate while flowing from near the cathode 14 toward the anode 18 as indicated in the drawings. The anode may be covered with dielectric material so that the anode does not absorb the cations flowing toward it.

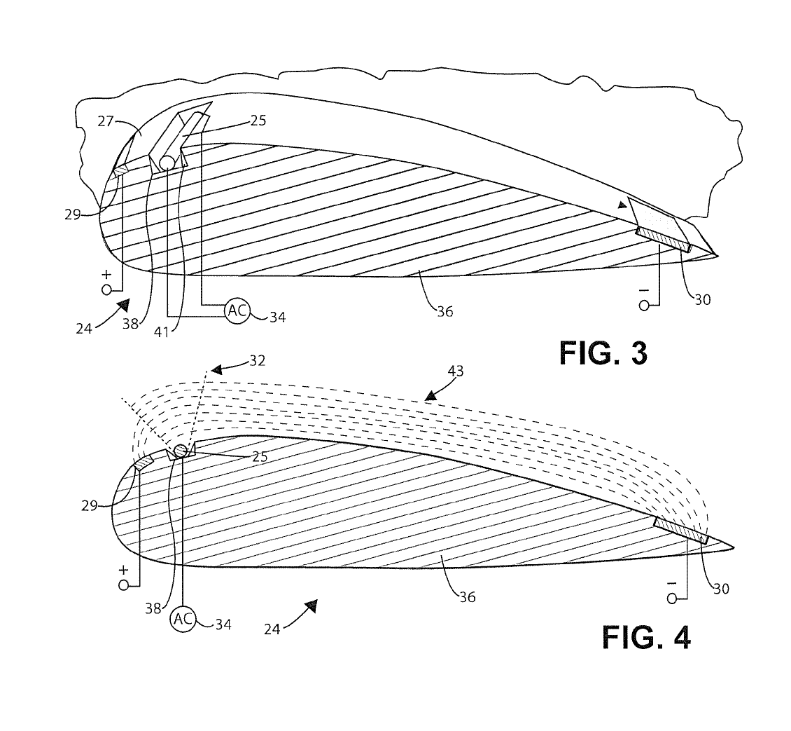

Referring now to FIGS. 3 and 4, there is shown an airfoil assembly 24, which is constructed in accordance with another embodiment, and which is similar to the airfoil assembly 10 except that it includes an air ionizing antenna 25 mounted on a leading portion 27 of an airfoil 36 for radiating an electromagnetic field to cause the electromagnetic field to ionize additional air flowing relative to the airfoil 36 to provide a denser plasma. The antenna may be positioned anywhere such as at the back of the airfoil pointing into the air flow.

The airfoil assembly 24 includes a cathode 29 and anode 30 which are similar to the respective cathode 14 and anode 18 for radiating an electric field there between. The ionizing antenna 25 may be disposed near and rearwardly of the cathode 29 and may be activated by a source of alternating current 34 for radiating electromagnetic energy upwardly away from the airfoil 36 to further ionize air flowing over the airfoil 36 in addition to the already ionized air caused by the cathode 29. The frequency of the alternating current may be adjusted to cause air to be ionized as it flows over the airfoil 36.

An elongated recess 38 receives the antenna 25 in a flush manner similar to the cathode 29 and the anode 32 to allow the upper surface of the airfoil 36 to be smoothly contoured. For the purpose of directing the radiation from the antenna 25 away from the upper surface of the airfoil 36 transversely toward the electric field, an elongated horn structure 41 is disposed within the elongated recess or opening 38 to direct the ionizing radiation beam upwardly away from the airfoil 36 and into the electric field caused by the cathode 29 and the anode 32 so that additional accelerating laminar flow ionized air is created to have a greater density thereof and move along a path of travel indicated at 43 toward the anode 30 as indicated in FIG. 4. As a result, unlike the prior art which confines the ionized air particles to the close contour of the airfoil, the relatively heavy particles of positive air ions or cations flowing relative to the airfoil 36 spread apart due to repulsion of the similarly charged ions creating lower pressure to cause an accelerating (hence lower pressure) laminar flow toward the negatively charged anode 32. While such laminar substantially smooth flow of accelerating particles as compared to the non-ionized air produces greater lift and less drag, the ionizing antenna 25 causes many more positively ionized air particles to be introduced into the stream of air flowing relative to the airfoil 36, whereby much greater lift and still less drag are provided. Thus, the airfoil 36 is much more efficient in its operation.

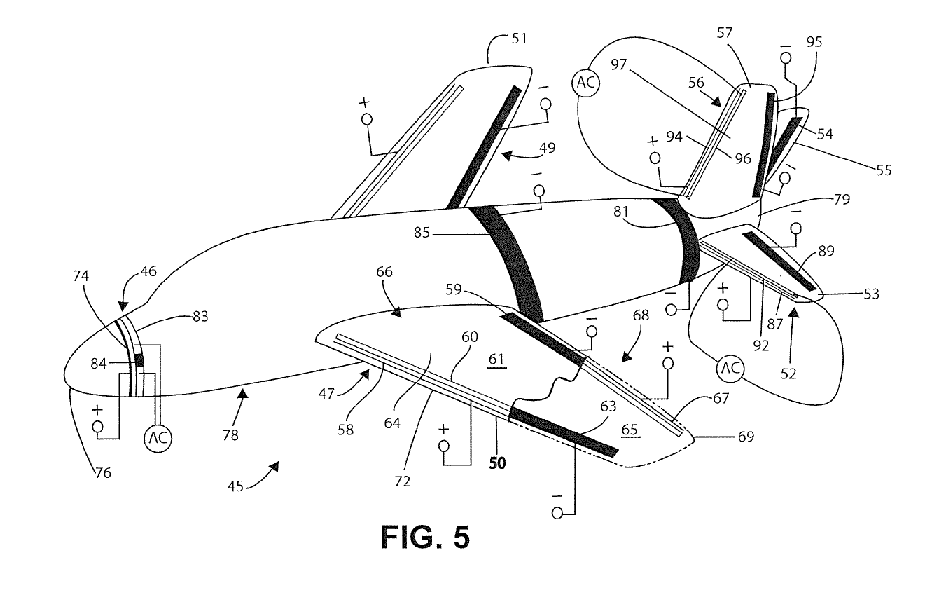

Referring now to FIGS. 5 and 6, there is shown other embodiments of airfoil assemblies constructed in accordance with various embodiments, being illustrated Incorporated on an aircraft 45. A fuselage airfoil assembly 46 is similar to the airfoil assembly 24 and facilitates greater lift and reduction of drag for the aircraft 45 as well as enhancing accelerating air flow relative to the aircraft 45. Similarly, a pair of airfoil assemblies 47 and 49 are Incorporated on wings 50 and 51 respectively. For a similar purpose, a pair of horizontal stabilizer airfoil assemblies 52 and 54 are mounted respectively on horizontal stabilizers 53 and 55. Also, for the purpose of controlling a vertical stabilizer 57 of the aircraft 45, a pair of left and right vertical stabilizer airfoil assemblies 56 and 63 are Incorporated into the vertical stabilizer 57 to facilitate steering of the aircraft 45. All these disclosed embodiments reduce drag due to the smoothing effect of the electric field on the plasma, and they increase thrust due to the accelerating force of the electric field on the plasma.

Considering now the wing airfoil assemblies 47 and 49 in greater detail, the left wing airfoil assembly 47 is generally similar to the right wing airfoil assembly 49, and is also similar to the airfoil assembly 24, and therefore only the left wing airfoil assembly 47 will now be described. The left airfoil assembly 47 includes a top left airfoil assembly 66, which is mounted on the upper surface 61 of a left wing 64 and includes a top cathode 58 and a top anode 59 which are similar to the cathode 14 and anode 18, together with a top ionizing antenna 60 which is similar to the ionizing antenna 25, whereby the left airfoil assembly 47 facilitates the lift as well as reduction of drag for the aircraft 45.

In order to further facilitate controlling the airfoil of fact on the wing 64, a bottom left airfoil assembly 98 mounted on the bottom surface 65 and is mounted in a reverse orientation to complement the airfoil assembly 66 on the upper surface 61. As a result, the airfoil assembly 98 can act to increase the pressure acting on the bottom surface 65 to facilitate an increase in lift. In this regard, the bottom left airfoil assembly 98 has a bottom cathode 67 disposed at the trailing portion 69 of the left wing 50, and the other components of the left airfoil assembly 98 are disposed at the leading portion 72 of the wing 50.

Considering now the fuselage airfoil assembly 46 in greater detail, the assembly 46 includes a cathode 74 at a leading portion 76 of the aircraft 45 and an anode 81 at a rear portion 79 of the fuselage 78, together with an ionizing antenna 83 disposed near and to the rear of the cathode 74 to facilitate a reduction in drag on the aircraft 45. The cathode 74, anode 81 and ionizing antenna 83 operated in a similar manner to the cathode 29, anode 30 and ionizing antenna 25 to ionize air flowing relative to the fuselage 78 to provide a laminar streamlined flow of air along the fuselage to decrease drag and increase thrust. The cathode 74 and the anode 81 are generally annular in shape, but other shapes and configurations may also be acceptable for certain applications. For example, instead of an annular configuration, they could be configured in a C-shape (not shown) and employed on the upper surface of the fuselage 78 to facilitate an increase in lift for the aircraft 45 as well as a reduction of drag.

The ionizing antenna 83 may also assume different configurations, such as a C-shape to also provide an increase in lift as well as a decrease in drag. The antenna 83 is generally annular in shape and has a gap 84 which may be filled with a suitable insulator so that the antenna can be energized in a similar manner as the ionizing antenna 25. The insulator may have an index of refraction to optimize the direction of the electromagnetic wave.

In order to help facilitate the establishment and maintenance of an electromagnetic field flowing relative to the body of the fuselage 78 of the aircraft 45, an intermediate anode 85 may be provided and is similar to the anode 81. The intermediate anode 85 may be disposed between the cathode 74 and the anode 81. Also, there may be other additional intermediate anodes or cathodes (not shown) located along the fuselage 78 as needed for certain applications.

Considering now the horizontal stabilizer airfoil assemblies 52 and 54, they are each generally similar to one another, and only the left horizontal stabilizer airfoil assembly 52 will now be described in greater detail. The assembly 52 includes a cathode 87 in an anode 89 together with an ionizing antenna 92, and is generally similar to the top left wing airfoil assembly 66 to provide for increased lift and a decrease in drag on the aircraft 45.

As shown in FIG. 5, the vertical stabilizer left airfoil assembly 56 will now be described in greater detail. The assembly 56 includes a cathode 94, and anode 95 and an ionizing antenna 96 which is generally similar to the corresponding components illustrated in FIGS. 3 and 4, and which is disposed on a left side 97 of the vertical stabilizer 57 to facilitate steering of the aircraft 45. The assembly 56 ionizes air flowing past the left side of the vertical stabilizer 57 to reduce the air pressure acting thereon relative to the right side of the vertical stabilizer 57. As a result of the differential pressure acting on the vertical stabilizer 57, the tail portion of the aircraft 45 moves in a leftward direction to steer the aircraft 45 in a rightward direction.

As shown in FIG. 6, similarly, a right side vertical stabilizer airfoil assembly 99 is positioned on the right side of the vertical stabilizer 57 and is similar to the left side vertical stabilizer assembly 56 but may be energized by a separate source of power to operate independently of the left side vertical stabilizer assembly 56. In this manner, when the right side assembly 99 is energized and the left side assembly 56 is not energized or is energized t o a lesser extent, the air pressure is reduced on the right side of the vertical stabilizer 57 relative to its left side, to cause the vertical stabilizer 57 to move in a rightward direction and thus to cause the aircraft 45 to move in a leftward direction.

In general, the biasing voltage on the cathodes and anodes should be maintained below arcing potential. As will become apparent to those skilled in the art, feedback control to eliminate or greatly reduce unwanted arcing, by limiting the voltage below a give safe threshold level may be employed. Also, the voltage differential between the cathodes and anodes may be changed controllably to help change the speed of the aircraft.

Although the invention has been described with reference to the above examples, it will be understood that many modifications and variations are contemplated within the true spirit and scope of the embodiments of the invention as disclosed herein. Many modifications and other embodiments of the invention set forth herein will come to mind to one skilled in the art to which the invention pertains having the benefit of the teachings presented in the foregoing descriptions and the associated drawings. Therefore, it is to be understood that the invention shall not be limited to the specific embodiments disclosed and that modifications and other embodiments are intended and contemplated to be included within the scope of the appended claims. Although specific terms are employed herein, they are used in a generic and descriptive sense only and not for purposes of limitation.

What is claimed is:

1. An airfoil assembly, comprising:
an airfoil;
a cathode disposed near a portion of the airfoil for initiating an electric field; and ionizing air moving relative thereto;
an anode disposed near an opposite portion of the airfoil for completing the electric field to accelerate and to cause smooth air flowing relative to the airfoil so that ionized positively charged air particles tend to separate and accelerate with reduced random motion continuously toward the anode in a substantially smooth laminar path of travel uninterruptedly.

2. An airfoil assembly according to claim 1, further including an air ionizing antenna mounted on the airfoil for radiating an electromagnetic field transversely toward the electric field; and a source of alternating current for energizing the antenna to cause the electromagnetic field to ionize additional air flowing relative to the airfoil.

3. An airfoil assembly according to claim 2, wherein the antenna is an elongated conductor, and the airfoil includes an elongated recess for receiving the elongated conductor.

4. An airfoil assembly according to claim 3, further including an elongated horn structure for guiding the electromagnetic radiation away from the airfoil and into the laminar path of travel of the positively charged air particles to increase the number of positively charged air ions accelerating toward the anode.

5. An airfoil assembly according to claim 1, wherein the cathode is annular in shape.

6. An airfoil assembly according to claim 5, wherein the anode is annular in shape.

7. An airfoil assembly according to claim 2, wherein the antenna is generally annular in shape having a gap.

8. An airfoil assembly according to claim 1, wherein the cathode and the anode are mounted on the top surface of the airfoil.

9. An airfoil assembly according to claim 1, further including a second cathode and a second anode mounted on the bottom surface of the airfoil, and wherein the second cathode is disposed near the trailing of the airfoil and the second anode is disposed near the leading portion of the airfoil.

10. An airfoil assembly according to claim 2, further including a second ionizing antenna disposed intermediate the cathode and anode.

11. An airfoil assembly according to claim 1, wherein the airfoil has two opposite symmetrically disposed surfaces, and includes a second cathode and a second anode, wherein the first mention cathode and anode are disposed on one surface and the second anode and cathode are disposed on the opposite surface.

12. An airfoil assembly according to claim 1, wherein the airfoil assembly forms a portion of one side of a vertical stabilizer of an aircraft, and further including a second similar airfoil assembly forming a second portion of an opposite side of the vertical stabilizer to facilitate steering the aircraft.

13. An airfoil assembly according to claim 1, wherein the airfoil assembly forms a portion of one side of a vertical stabilizer of an aircraft, and further including a second similar airfoil assembly forming a second portion of an opposite side of the vertical stabilizer to facilitate steering the aircraft.

14. A method of improving laminar air flow over an airfoil, comprising:
positively charging air ions near a portion edge of the airfoil;
completing the electric field to ionize air flowing past the airfoil so that ionized positively charged air particles tend to separate and flow continuously toward the anode in a smooth laminar path of travel uninterruptedly.

15. A method according to claim 14, further including radiating an electromagnetic field with an air ionizing antenna to ionize additional air flowing relative to the airfoil.

16. An airfoil assembly, comprising:
an airfoil;
an air ionizing antenna mounted on the airfoil for radiating an electromagnetic field away from a surface of the airfoil; and
a source of alternating current for energizing the antenna at an air ionizing frequency to cause the electromagnetic field to ionize air flowing relative to the airfoil.

17. An airfoil assembly, according to claim 16, wherein the ionizing antenna includes an elongated conductor disposed in a recess in the surface of the airfoil.

18. An airfoil assembly according to claim 17, wherein the antenna further includes an elongated horn structure for guiding the electromagnetic field.
